(19) United States
(12) Patent Application Publication
(10) Pub. No.: US 2009/0322074 A1
(43) Pub. Date: Dec. 31, 2009

(54) External Hydraulic Tieback Connector

(75) Inventors: Joseph W. Pallini, JR., Tomball, TX (US); Steven Wong, Houston, TX (US)

Correspondence Address: Patent Department;GE Oil & Gas, 4424 West Sam Houston Parkway North, Suite 100, Houston, TX, 77041, US

(73) Assignee: Vetco Gray Inc., Houston, TX (US)

(21) Appl. No.: 12/492,340

(22) Filed: Jun. 26, 2009

Related U.S. Application Data
(60) Provisional application No. 61/075,809, filed on Jun. 26, 2008.

(51) Int. Cl. F16L 19/00

(52) U.S. Cl. 285/123.1

(57) ABSTRACT

A connector for tie back liners.

### CROSS REFERENCE TO RELATED APPLICATIONS

This application claims the benefit of the filing date of U.S. provisional patent application Ser. No. 61/075,809, filed on Jun. 26, 2008, the disclosure of which is incorporated herein by reference.

### FIELD OF THE INVENTION

This invention relates in general to offshore drilling and well production equipment, and in particular to connectors for tieback external risers.

### BRIEF DESCRIPTION OF THE DRAWINGS

FIG. 1 is a fragmentary cross sectional illustration of an exemplary embodiment of an external hydraulic tieback connector.

FIG. 2 is a fragmentary cross sectional illustration of an exemplary embodiment of the external hydraulic tieback connector of FIG. 1 during the landing of the connector onto a wellhead.

FIG. 3 is a fragmentary cross sectional illustration of an exemplary embodiment of the external hydraulic tieback connector of FIG. 2 during the locking of the connector onto the wellhead.

FIG. 4 is a fragmentary cross sectional illustration of an exemplary embodiment of the external hydraulic tieback connector of FIG. 3 during the unlocking of the connector from the wellhead.

FIG. 5 is a fragmentary cross sectional illustration of an exemplary embodiment of the external hydraulic tieback connector of FIG. 3 during the unlocking of the connector from the wellhead.

FIG. 6 is a fragmentary cross sectional illustration of an exemplary embodiment of an external hydraulic tieback connector.

FIG. 7 is a fragmentary cross sectional illustration of an exemplary embodiment of the external hydraulic tieback connector of FIG. 6 during the locking of the connector onto the wellhead.

### DETAILED DESCRIPTION OF THE EXEMPLARY EMBODIMENTS

In the drawings and description that follows, like parts are marked throughout the specification and drawings with the same reference numerals, respectively. The drawings are not necessarily to scale. Certain features of the invention may be shown exaggerated in scale or in somewhat schematic form and some details of conventional elements may not be shown in the interest of clarity and conciseness. The present invention is susceptible to embodiments of different forms. Specific embodiments are described in detail and are shown in the drawings, with the understanding that the present disclosure is to be considered an exemplification of the principles of the invention, and is not intended to limit the invention to that illustrated and described herein. It is to be fully recognized that the different teachings of the embodiments discussed below may be employed separately or in any suitable combination to produce desired results. The various characteristics mentioned above, as well as other features and characteristics described in more detail below, will be readily apparent to those skilled in the art upon reading the following detailed description of the embodiments, and by referring to the accompanying drawings.

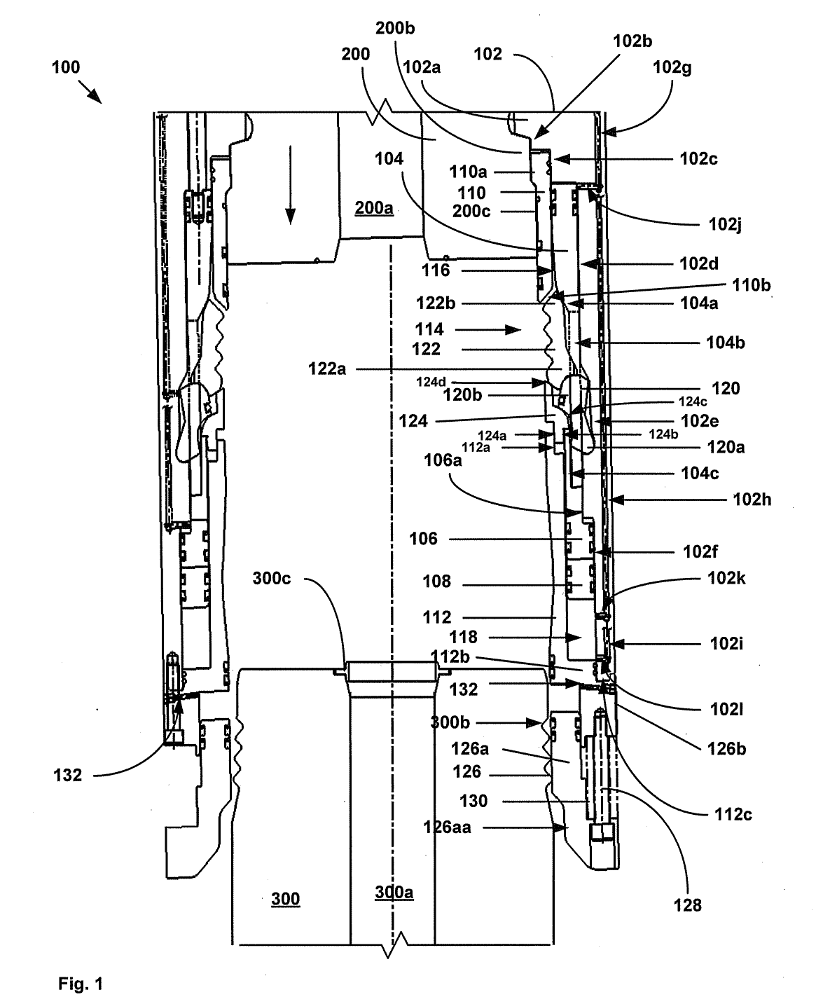

Referring initially to FIG. 1, an exemplary embodiment of a tieback connector assembly 100 includes an outer tubular sleeve 102 that includes an inner flange 102a at one end having a stepped internal shoulder 102b, an annular internal recess 102c, an annular internal recess 102d, an annular recess 102e, and an annular internal recess 102f at another end. The sleeve 102 further defines a longitudinal flow passage 102g, a longitudinal flow passage 102h, a longitudinal flow passage 102i, a radial flow passage 102j that connects the longitudinal flow passage 102g to the internal annular recess 102d, a radial flow passage 102k that connects the longitudinal flow passage 102h to the internal annular recess 102f, and a radial flow passage 102l that connects the longitudinal flow passage 102i to a lower location within the internal annular recess 102f.

A tubular actuating sleeve 104 is received within and mates with the annular internal recess 102d of the outer tubular sleeve 102 that defines a tapered annular internal recess 104a at one end, a plurality of circumferentially spaced apart radial windows 104b, and a lower tubular end 104c.

A tubular piston 106 that includes an annular external recess 106a at one end is received within and mates with the internal annular recess 102f of the outer tubular sleeve 102. In an exemplary embodiment, the external annular recess 106a of the tubular piston 106 mates with and in received within the internal annular recess 102d of the outer tubular sleeve 102 and the upper end of the tubular piston 106 is threadably coupled to the lower tubular end 104c of the actuating sleeve 104.

A tubular piston 108 is received within and mates with the internal annular recess 102f of the outer tubular sleeve 102. The tubular piston 108 is also positioned proximate and below the tubular piston 106.

An inner tubular sleeve 110 includes an internal flange 110a at one end and an external tapered annular recess 110b at another end. The end of the inner tubular sleeve 110 is received within and mates with the annular internal recess 102c of the outer tubular sleeve 102.

An inner tubular sleeve 112 includes an external annular recess 112a at one end and an external flange 112b having a bottom channel 112c at another end. The bottom channel 112c at the other end of the inner tubular sleeve 112 receives and mates with the other end of the inner tubular sleeve 102.

The opposing ends of the inner tubular sleeves, 110 and 112, are spaced apart from one another and thereby define an annular window 114 therebetween.

The internal annular recess 102d of the external tubular sleeve 102 and the inner tubular sleeve 110 define therebetween an annular chamber 116 that receives one end of the tubular actuating sleeve 104 for longitudinal displacement therein. The internal annular recess 102f of the external tubular sleeve 102 and the inner tubular sleeve 112 define therebetween an annular piston chamber 118 that receives the tubular pistons, 106 and 108, for longitudinal displacement therein.

One side of a lower end 120a of a pivotable load transfer element 120 is received within the internal annular recess 102e of the external tubular sleeve 102 for pivoting motion relative to the external tubular sleeve. In an exemplary embodiment, a plurality of circumferentially spaced apart load transfer element elements 120 are received within the internal annular recess 102e of the external tubular sleeve 102 for pivoting motion relative to the external tubular sleeve. The other side of the lower end 120a of each load transfer element 120 is mounted for pivoting motion relative to the tubular actuating sleeve 104. One side of an upper end 120b of each load transfer element 120 is received within the internal annular recess 102e of the external tubular sleeve 102 for radial displacement relative to the external tubular sleeve. The other side of the upper end 120b of each load transfer element 120 extends through the corresponding circumferentially spaced apart radial window 104b of the tubular actuating sleeve 104 for movement therein.

A lower end 122a of a locking dog 122 includes a recessed curved surface that mates with an external curved surface of the upper end 120b of the load transfer element 120 for pivoting motion relative thereto. In this manner, a plurality of circumferentially spaced apart locking dogs 122 are provided that are operably coupled to one or more corresponding load transfer elements 120. In an exemplary embodiment, the load transfer elements 120 and the locking dogs 122 may be staggered with respect to one another in a circumferential direction. As a result, each locking dog 122 may be supported by and paired with circumferential opposing end portions of adjacent load transfer elements 120.

The lower end 122a of the locking dog 122 is also at least partially positioned within the corresponding circumferentially spaced apart radial window 104b of the tubular actuating sleeve 104 for movement therein. An upper end 122b of the locking dog 122 includes a tapered inner surface that mates with the tapered external annular recess 110b of the inner tubular sleeve 110 and a tapered outer surface that mates with the tapered annular internal recess 104a of the tubular actuating sleeve 104. An inner face of the locking dog 122 includes a profiled outer surface.

A retraction sleeve 124 includes an internal annular recess 124a at one end that mates with the external annular recess 112a of the inner tubular sleeve 112, an external annular recess 124b at the one end that mates with and receives the other end of the tubular actuating sleeve 104, a curved outer external surface 124c that mates with complementary curved surfaces provided on each of the load transfer elements 120, and a tapered external surface 124d at another end that mates with a portion of the lower ends 122a of each of the locking dogs 122 for retaining and retracting the lower ends of the locking dogs.

An end of a telescoping tubular guide assembly 126 is coupled to the other end of the external tubular sleeve 102 that includes an inner telescoping tubular member 126a having a tapered opening 126aa at lower end thereof and an outer tubular support 126b that is coupled to the other end of the external tubular sleeve. In an exemplary embodiment, the inner telescoping tubular member 126a of the tubular guide assembly 126 telescopes downwardly from the outer tubular support 126b of the tubular guide assembly such that the inner telescoping tubular member of the tubular guide assembly may be displaced in a longitudinal direction relative to the outer tubular support of the tubular guide assembly and the other end of the external tubular sleeve 102. In an exemplary embodiment, the inner telescoping tubular member 126a of the tubular guide assembly 126 is coupled to the outer tubular support 126b of the tubular guide assembly by one or more retaining bolts 128 and is spring biased away from the end of the inner telescoping tubular member of the tubular guide assembly by springs 130 positioned around each of the bolts.

Flow passages 132 are also defined within and extend through the outer tubular support 126b of the tubular guide assembly 126 for conveying fluidic materials therethrough. In an exemplary embodiment, the flow passages 132 further include conventional orifices for controlling the rate of fluid flow therethrough.

In an exemplary embodiment, the telescoping support 126b of the tubular guide assembly 126 may be provided as an outer annular extension of the lower end of the inner tubular sleeve 112.

During operation, as illustrated in FIG. 1, an upper end of the assembly 100 is coupled to a lower end of a conventional tubular liner 200 that defines an internal passage 200a and includes an external flange 200b at the lower end having a stepped external flange 200c. In particular, during assembly, the external flange 200b of the lower end of the liner 200 is received within and is coupled to the internal flange 102a of the external tubular sleeve 102 and the stepped external flange 200c of the lower end of the liner 200 is received within and is coupled to the internal flange 110a at the end of the inner tubular sleeve 110. In this manner, the lower end of the liner 200 is coupled to the upper end of the assembly 100 is such a manner are to prevent longitudinal displacement of the liner relative to the assembly. In an exemplary embodiment, the liner 200 provides an external riser for connection to a subsea wellhead.

After coupling the assembly 100 to the lower end of the liner 200, the assembly and liner are positioned proximate an end of a conventional wellhead 300 that defines an internal passage 300a and includes an external profiled surface 300b proximate the end of the wellhead and a tubular gasket 300c within an annular recess provided at the upper end of the wellhead. In an exemplary embodiment, the assembly 100 and liner 200 are then displaced toward the end of the wellhead 300 until the end of the wellhead is received within the tapered opening 122a of the tubular guide assembly 122. In an exemplary embodiment, the wellhead 300 is a subsea wellhead.

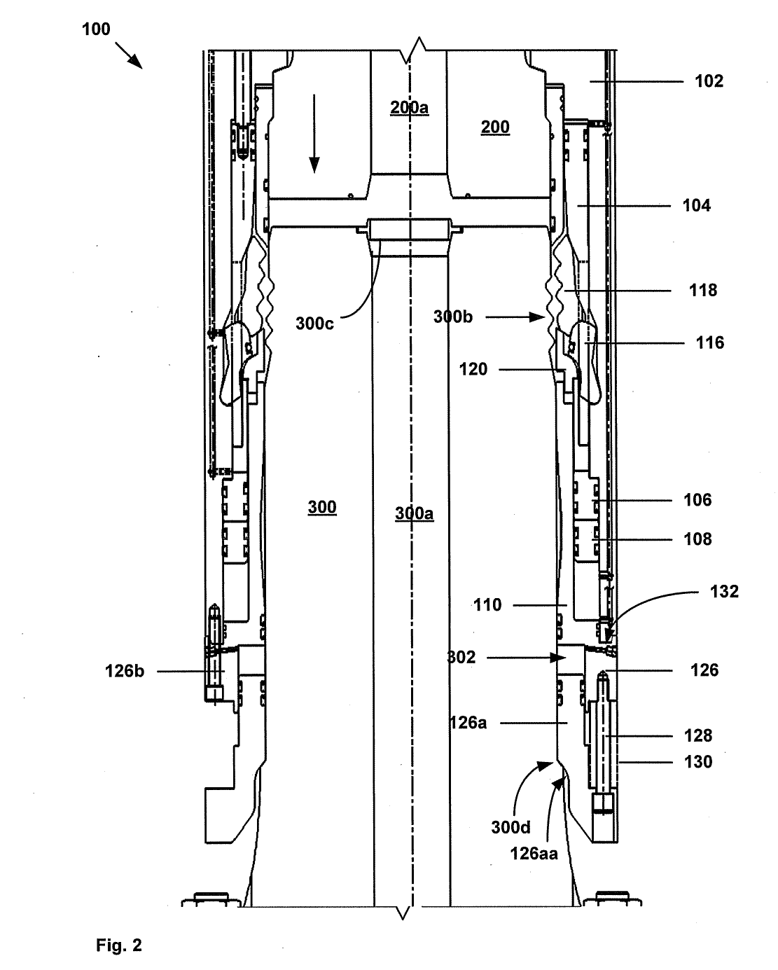

In an exemplary embodiment, as illustrated in FIG. 2, the assembly 100 and liner 200 are then further displaced toward the end of the wellhead 300 until the tapered opening 126a of the tubular guide assembly 126 engages load shoulders 300d provided on the wellhead. During the engagement of the tubular guide assembly 126 with the wellhead 300, an annular chamber 302 is defined by, and bounded between, the exterior surface of the wellhead and the axial annular space defined between the lower end face of the inner tubular sleeve 110, the upper end face of the inner telescoping tubular member 126a of the tubular guide assembly 126, and the inner surface of the outer tubular support 126b of the tubular guide assembly.

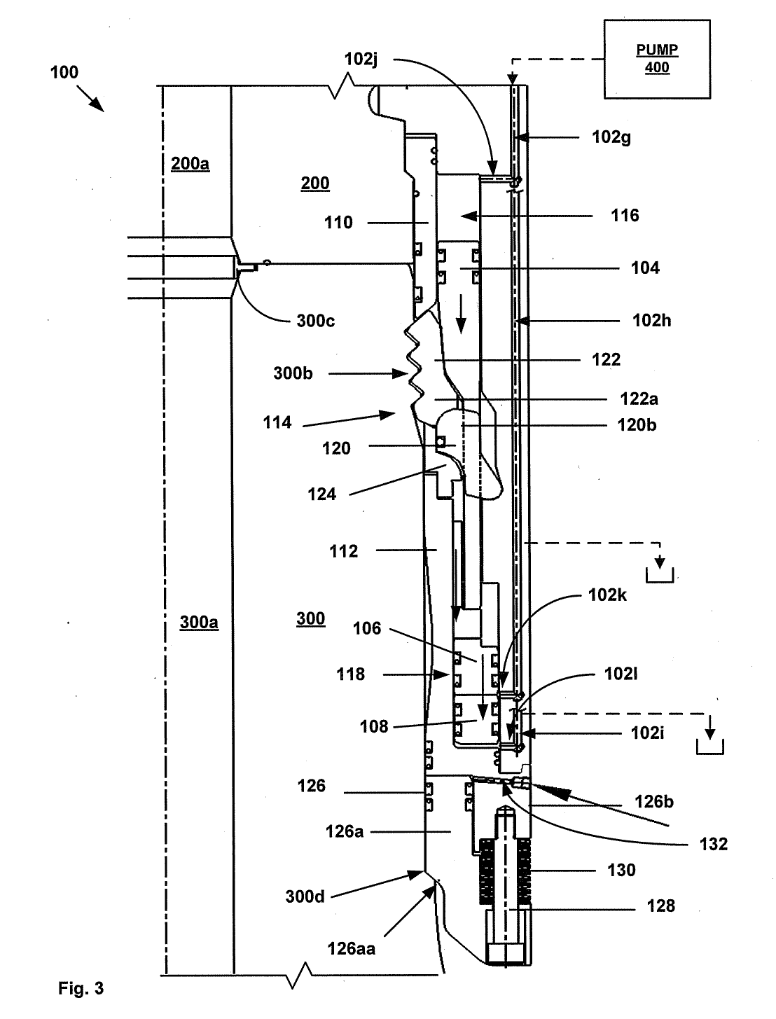

In an exemplary, as illustrated in FIG. 3, after the tapered opening 126a of the tubular guide assembly 126 engages the load shoulders 300d provided on the wellhead 300, the assembly 100 and liner 200 are then further displaced toward the end of the wellhead 300 until the lower end face of liner rests on the upper end face of the end of the wellhead. As a result, the tubular gasket 300c is compressed between the opposing open ends of the liner 200 and wellhead 300 thereby fluidicly sealing the interface therebetween. Furthermore, as a result of the further displacement of the assembly 100 and liner 200, the springs 130 of the tubular guide assembly 126 are compressed thereby permitting the inner tubular telescoping portion 126a of the tubular guide assembly 126 to telescope into and towards the outer tubular support portion 126b of the tubular guide assembly. As a result, fluidic material within the chamber 302 is exhausted out of the chamber through the passages 132. In an exemplary embodiment, the combination of the springs 130, on the one hand, and the fluidic chamber 302 and passages 132, on the other hand, provide a spring-damper shock absorber system that controllably absorbs energy and limits the rate of displacement of the inner tubular telescoping portion 126a relative to the outer tubular support portion 126b of the guide assembly 126 during the engagement of the guide assembly 126 with the wellhead 300.

In an exemplary embodiment, the energy absorbed by the springs 130, fluidic chamber 302 and passages 132, during the further displacement of the assembly 100 and liner 200 minimizes shock loads on the assembly 100, liner 200 and wellhead 300. Furthermore, as a result, energy absorbed by the springs 130, fluidic chamber 302 and passages 132, during the further displacement of the assembly 100 and liner 200 prevents damage to the gasket 300c thereby providing a soft landing of the end of the liner on the opposing end of the wellhead 300. Furthermore, as a result of the further displacement of the assembly 100 and liner 200, the locking dogs 122 of the assembly 100 are positioned in opposing relation to the profiled external surface 300b of the wellhead 300. Furthermore, as a result, energy absorbed by the springs 130, fluidic chamber 302 and passages 132, during the further displacement of the assembly 100 and liner 200 prevents distortion of the gasket 300c thereby preventing, for example, flattening of the vertically aligned portion of the gasket into engagement with the tapered open ends of the passages, 200a and 300a, of the liner 200 and wellhead 300, respectively.

The locking dogs 122 are then displaced into engagement with the profiled external surface 300b of the wellhead 300 thereby locking the lower end of the liner 200 onto the opposing end of the wellhead. In particular, a pump 400 may be operated to pump fluid into and through the passages, 102g and 102j, thereby pressurizing the portion of the annular chamber 116 above the top end face of the tubular actuating sleeve 104.

As a result of the pressurizing of the portion of the annular chamber 116 above the top end face of the tubular actuating sleeve 104, the tubular actuating sleeve is displaced in a downward direction relative to the locking dogs 122 thereby impacting and displacing the locking dogs radially inwardly through the annular window 114 into engagement with the profiled external surface 300b of the wellhead 300. The downward displacement of the tubular actuating sleeve 104 further causes the inner surface of the tubular actuating sleeve to surround and engage the outer surface of the locking dogs 122 thereby preventing the locking dogs from being disengaged from the profiled external surface 300b of the wellhead 300. In an exemplary embodiment, during the downward displacement of the tubular actuating sleeve 104, fluid is drained from the piston chamber 118 through the radial passages, 102k and 102l, into the longitudinal passages, 102h and 102i, respectively.

As illustrated in FIG. 3, during the operation of the assembly 100 to pivot and radially displace the locking dogs 122 into engagement with the profiled external surface 300b of the wellhead 300, the ends 122a of the locking dogs are supported on the ends 120b of the load transfer elements 120. During the operation of the assembly 100 to pivot and radially displace the locking dogs 122 into engagement with the profiled external surface 300b, the load transfer elements 120 provide pivoting links that swing in and out of the assembly. As a result, the load transfer elements 120 change the load angle between the assembly 100 and the locking dogs 122 while the locking dogs are displaced into engagement with the profiled external surface 300b of the wellhead 300. In an exemplary embodiment, the more the locking dogs 122 engage the profiled external surface 300b of the wellhead 300, the resistance to engagement in a radial direction also may increase. However, because the load angle between the assembly 100 and the locking dogs 122, while the locking dogs are displaced into engagement with the profiled external surface 300b of the wellhead 300, increases within increasing engagement, the increased load angle provides increased inward radial force to assist the engagement of the locking dogs with the profiled external surface of the wellhead.

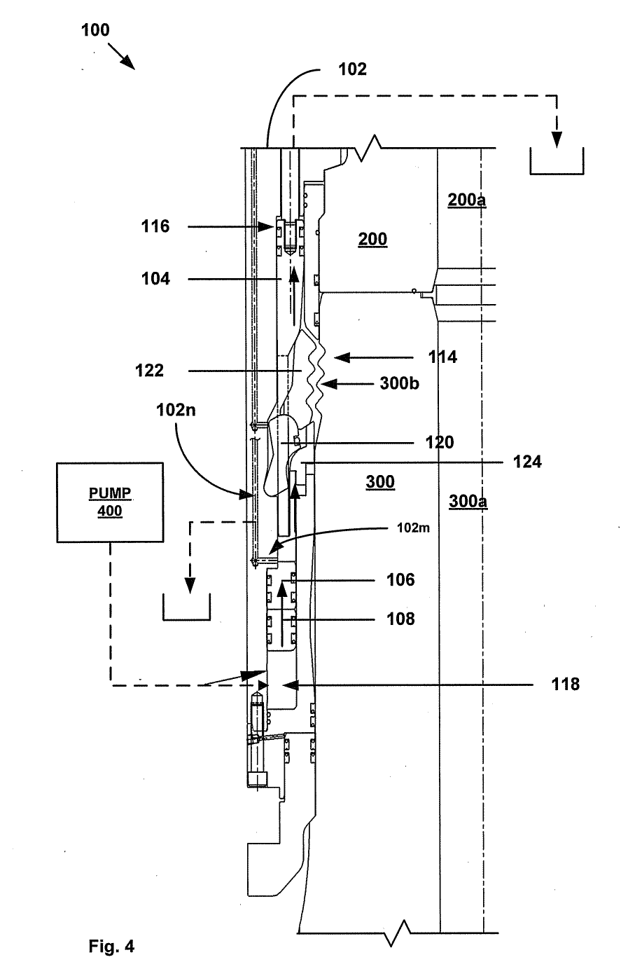

Referring now to FIG. 4, in an exemplary embodiment, the locking dogs 122 may be disengaged from the profiled external surface 300b of the wellhead 300 by displacing the tubular actuating sleeve 104 upwardly relative to the locking dogs. In particular, the pump 400 may be operated to pump fluid into and through the passages, 102i and 102l, thereby pressurizing the portion of the annular chamber 118 below the tubular pistons, 106 and 108. In an exemplary embodiment, during the pressurizing of the portion of the annular chamber 118 below the tubular pistons, 106 and 108, fluid is drained from the portion of the annular chamber 118 above the tubular pistons, 106 and 108, through passages, 102m and 102n, defined in the tubular sleeve 102 and fluid is drained from the annular chamber 116 through the passages, 102g and 102j.

As a result of the pressurizing of the portion of the annular chamber 118 below the tubular pistons, 106 and 108, the pistons and the tubular actuating sleeve 104 are displaced in an upward direction relative to the locking dogs 122 thereby permitting the locking dogs to be displaced radially outwardly through the annular window 114 out of engagement with the profiled external surface 300b of the wellhead 300. The upward displacement of the tubular actuating sleeve 104 further causes the inner surface of the tubular actuating sleeve to no longer surround and engage the outer surface of the locking dogs 122 thereby permitting the locking dogs to be disengaged from the profiled external surface 300b of the wellhead 300.

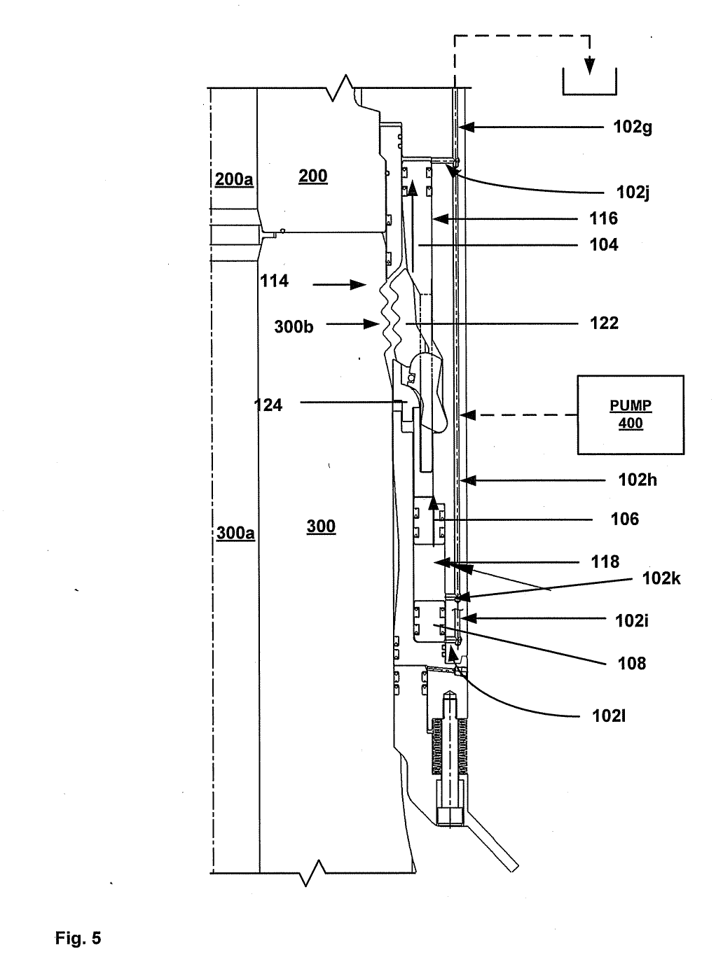

Referring now to FIG. 5, in an exemplary embodiment, the locking dogs 122 may be disengaged from the profiled external surface 300b of the wellhead 300 by displacing the tubular actuating sleeve 104 upwardly relative to the locking dogs. In particular, the pump 400 may be operated to pump fluid into and through the passages, 102h and 102k, thereby pressurizing the portion of the annular chamber 118 below the tubular piston 106 and above the tubular piston 108. In an exemplary embodiment, during the pressurizing of the portion of the annular chamber 118 below the tubular piston 106 and above the tubular piston 108, fluid is drained from the annular chamber 116 through the passages, 102g and 102j.

As a result of the pressurizing of the portion of the annular chamber 118 below the tubular piston 106 and above the tubular piston 108, the tubular piston 106 and the tubular actuating sleeve 104 are displaced in an upward direction relative to the locking dogs 122 thereby permitting the locking dogs to be displaced radially outwardly through the annular window 114 out of engagement with the profiled external surface 300b of the wellhead 300. The upward displacement of the tubular actuating sleeve 104 further causes the inner surface of the tubular actuating sleeve to no longer surround and engage the outer surface of the locking dogs 122 thereby permitting the locking dogs from being disengaged from the profiled external surface 300b of the wellhead 300. In an exemplary embodiment, during the upward displacement of the tubular actuating sleeve 104, fluid is drained from the piston chamber 116 through the passages, 102g and 102j.

In an exemplary embodiment, once the locking dogs 122 have been disengaged from the profiled external surface 300b of the wellhead 300, the assembly 100 and liner 200 may be displaced upwardly relative to the wellhead 300.

As illustrated above in FIGS. 4 and 5, in an exemplary embodiment, during the upward displacement of the actuating sleeve 104, the upper end of the actuating sleeve engages the external annular recess 124b of the retraction sleeve 124 thereby displacing the retraction sleeve upwardly. As a result, the retraction sleeve 124 lifts and thereby displaces the locking dogs 122 into a retracted position out of engagement with the external profile 300b of the wellhead 300.

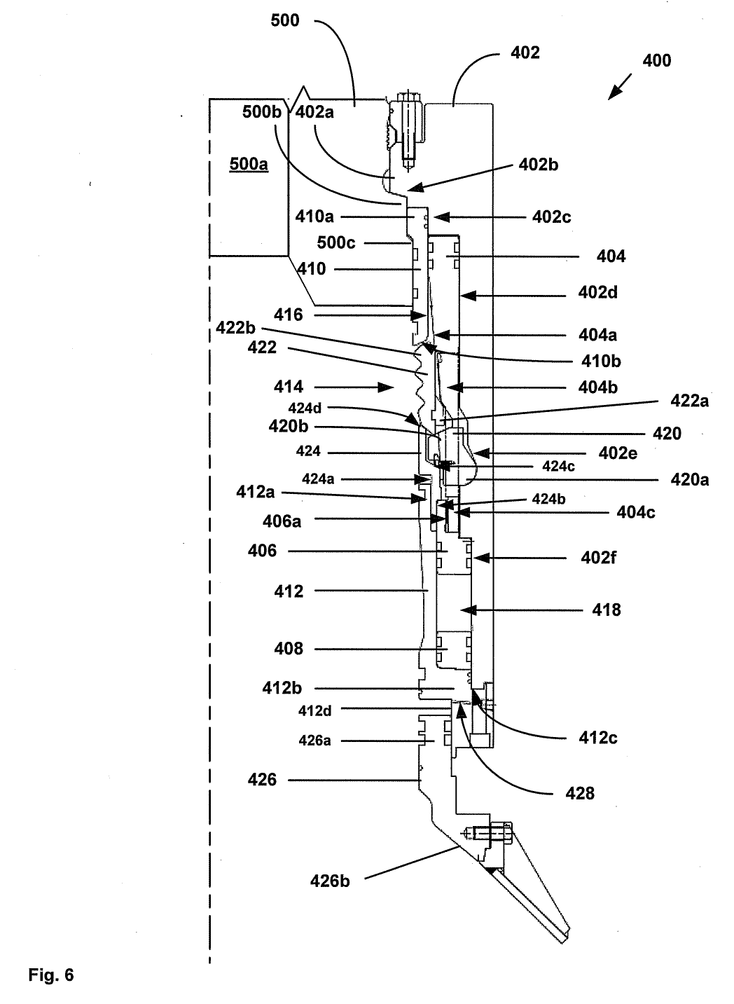

Referring initially to FIG. 6, an exemplary embodiment of a tieback connector assembly 400 includes an outer tubular sleeve 402 that includes an inner flange 402a at one end having a stepped internal shoulder 402b, an annular internal recess 402c, an annular internal recess 402d, an annular internal recess 402e, and an annular internal recess 402f at another end.

A tubular actuating sleeve 404 is received within and mates with the annular internal recess 402d of the outer tubular sleeve 402 that defines a tapered annular internal recess 404a at one end, a plurality of circumferentially spaced apart radial windows 404b, and a lower tubular end 404c at another end.

A tubular piston 406 that includes an annular external recess 406a at one end is received within and mates with the internal annular recess 402f of the outer tubular sleeve 402. In an exemplary embodiment, the external annular recess 406a of the tubular piston 406 mates with and in received within the internal annular recess 402d of the outer tubular sleeve 402 and the upper end of the tubular piston is threadably coupled to the lower tubular end 404c of the tubular actuating sleeve 404.

A tubular piston 408 is received within and mates with the internal annular recess 402f of the outer tubular sleeve 402. The tubular piston 408 is also positioned proximate and below the tubular piston 406.

An inner tubular sleeve 410 includes an internal flange 410a at one end and an external tapered annular recess 410b at another end. The end of the inner tubular sleeve 410 is received within and mates with the annular internal recess 402c of the outer tubular sleeve 402.

An inner tubular sleeve 412 includes an external annular recess 412a at one end and an external flange 412b having a bottom channel 412c and an internal annular recess 412d at another end. The bottom channel 412c at the other end of the inner tubular sleeve 412 receives and mates with the other end of the inner tubular sleeve 402.

The opposing ends of the inner tubular sleeves, 410 and 412, are spaced apart from one another and thereby define an annular window 414 therebetween.

The internal annular recess 402d of the external tubular sleeve 402 and the inner tubular sleeve 410 define therebetween an annular chamber 416 that receives one end of the tubular actuating sleeve 404 for longitudinal displacement therein. The internal annular recess 402f of the external tubular sleeve 402 and the inner tubular sleeve 412 define therebetween an annular piston chamber 418 that receives the tubular pistons, 406 and 408, for longitudinal displacement therein.

One side of a lower end 420a of a load transfer element 420 is received within the internal annular recess 402e of the external tubular sleeve 402. In an exemplary embodiment, a plurality of circumferentially spaced apart load transfer element elements 420 are received within the internal annular recess 402e of the external tubular sleeve 402. One side of an upper end 420b of each load transfer element 420 is received within the internal annular recess 402e of the external tubular sleeve 402. The other side of the upper end 420b of each load transfer element 420 extends through the corresponding circumferentially spaced apart radial window 404b of the tubular actuating sleeve 404.

A lower end 422a of a locking dog 422 includes a surface that mates with an external surface of the upper end 420b of the load transfer element 420 for sliding motion relative thereto. In this manner, a plurality of circumferentially spaced apart locking dogs 422 are provided that are paired with a corresponding load transfer element 420. The lower end 422a of the locking dog 422 is also at least partially positioned within the corresponding circumferentially spaced apart radial window 404b of the tubular actuating sleeve 404 for movement therein. An upper end 422b of the locking dog 422 includes a tapered inner surface that mates with the tapered external annular recess 410b of the inner tubular sleeve 410 and a tapered outer surface that mates with the tapered annular internal recess 404a of the tubular actuating sleeve 404. An inner face of the locking dog 422 includes a profiled outer surface.

In an exemplary embodiment, the load transfer elements 420 and the locking dogs 422 may be staggered with respect to one another in a circumferential direction. As a result, each locking dog 422 may be supported by and paired with circumferential opposing end portions of adjacent load transfer elements 420.

A retraction sleeve 424 includes an internal annular recess 424a at one end that mates with the external annular recess 412a of the inner tubular sleeve 412, an external annular recess 424b at the one end that mates with and receives the other end of the tubular actuating sleeve 404, an outer external surface 424c that mates with complementary surfaces provided on each of the load transfer elements 420, and a tapered external surface 424d at another end that mates with a portion of the lower ends 422a of each of the locking dogs 422 for retaining and retracting the lower ends of the locking dogs.

An end of a telescoping tubular guide assembly 426 is coupled to the other end of the inner tubular sleeve 412 that includes an inner telescoping tubular member 426a that mates with and is received within the internal annular recess 412d of the inner tubular sleeve 412 and includes a tapered opening 426b at lower end thereof. In an exemplary embodiment, the inner telescoping tubular member 426a of the tubular guide assembly 426 telescopes downwardly from the inner tubular sleeve 412 such that the inner telescoping tubular member 426a of the tubular guide assembly 426 may be displaced in a longitudinal direction relative to the inner tubular sleeve 412. In an exemplary embodiment, the inner telescoping tubular member 426a of the tubular guide assembly 426 is coupled to the inner tubular sleeve 412 by one or more retaining bolts (not shown) and is spring biased away from the end of the inner tubular sleeve 412 by springs (not shown) positioned around each of the bolts.

Flow passages 428 are also defined within and extend through the inner tubular sleeve 412 for conveying fluidic materials therethrough. In an exemplary embodiment, the flow passages 428 further include conventional orifices for controlling the rate of fluid flow therethrough.

In an exemplary embodiment, the design and operation of the tubular guide assembly 426 is substantially identical to the design and operation of the tubular guide assembly 126 illustrated and described above with reference to FIGS. 1-3.

During operation, as illustrated in FIG. 6, an upper end of the assembly 400 is coupled to a lower end of a conventional tubular liner 500 that defines an internal passage 500a and includes an external flange 500b at the lower end having a stepped external flange 500c. In particular, during assembly, the external flange 500b of the lower end of the liner 500 is received within and is coupled to the internal flange 402a of the external tubular sleeve 402 and the stepped external flange 500c of the lower end of the liner 500 is received within and is coupled to the internal flange 410a at the end of the inner tubular sleeve 410. In this manner, the lower end of the liner 500 is coupled to the upper end of the assembly 400 is such a manner are to prevent longitudinal displacement of the liner relative to the assembly. In an exemplary embodiment, the liner 500 provides an external riser for connection to a subsea wellhead.

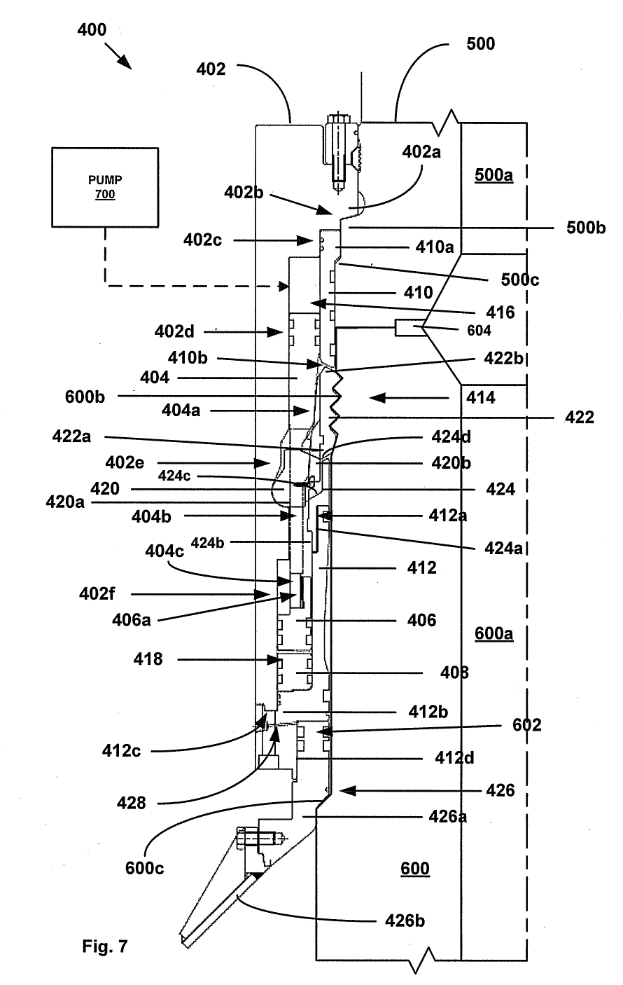

As illustrated in FIG. 7, after coupling the assembly 400 to the lower end of the liner 500, the assembly and liner are positioned proximate an end of a conventional wellhead 600 that defines an internal passage 600a and includes an external profiled surface 600b proximate the end of the wellhead. In an exemplary embodiment, the assembly 400 and liner 500 are then displaced toward the end of the wellhead 600 until the end of the wellhead is received within the tapered opening 426b of the tubular guide assembly 426. In an exemplary embodiment, the wellhead 600 is a subsea wellhead.

In an exemplary embodiment, as illustrated in FIG. 7, the assembly 100 and liner 200 are then further displaced toward the end of the wellhead 600 until the tapered opening 126a of the tubular guide assembly 126 engages load shoulders 600c provided on the wellhead. During the engagement of the tubular guide assembly 126 with the wellhead 600, an annular chamber 602 is defined by, and bounded between, the exterior surface of the wellhead and the axial annular space defined between the lower end face of the inner tubular sleeve 412 and the upper end face of the inner telescoping tubular member 426a of the tubular guide assembly 426.

In an exemplary, as illustrated in FIG. 7, after the tapered opening 426b of the tubular guide assembly 426 engages load shoulders 600c provided on the wellhead 600, the assembly 400 and liner 500 are then further displaced toward the end of the wellhead 600 until the lower end face of liner rests on the upper end face of the end of the wellhead. As a result, a tubular gasket 604 is compressed between the opposing open ends of the liner 500 and wellhead 600 thereby fluidicly sealing the interface therebetween. Furthermore, as a result of the further displacement of the assembly 400 and liner 500, the springs of the tubular guide assembly 426 are compressed thereby permitting the inner tubular telescoping portion 426a of the tubular guide assembly 426 to telescope into and towards the inner tubular sleeve 412. As a result, fluidic material within the chamber 602 is exhausted out of the chamber through the passages 428. In an exemplary embodiment, the combination of the springs, on the one hand, and the fluidic chamber 602 and passages 428, on the other hand, provide a spring-damper shock absorber system that controllably absorbs energy and limits the rate of displacement of the inner tubular telescoping portion 126a relative to the inner tubular sleeve 412 during the engagement of the guide assembly 426 with the wellhead 600.

In an exemplary embodiment, the energy absorbed by the springs, fluidic chamber 602 and passages 428, during the further displacement of the assembly 400 and liner 500 minimizes shock loads on the assembly 400, liner 500 and wellhead 600. Furthermore, as a result, energy absorbed by the springs, fluidic chamber 602 and passages 428, during the further displacement of the assembly 400 and liner 500 prevents damage to the gasket 604 thereby providing a soft landing of the end of the liner on the opposing end of the wellhead 600. Furthermore, as a result of the further displacement of the assembly 400 and liner 500, the locking dogs 422 of the assembly 400 are positioned in opposing relation to the profiled external surface 600b of the wellhead 600. Furthermore, as a result, energy absorbed by the springs, fluidic chamber 602 and passages 428, during the further displacement of the assembly 400 and liner 500 prevents distortion of the gasket 604 thereby preventing, for example, flattening of the vertically aligned portion of the gasket into engagement with the tapered open ends of the passages, 500a and 600a, of the liner 500 and wellhead 600, respectively.

The locking dogs 422 are then displaced into engagement with the profiled external surface 600b of the wellhead 600 thereby locking the lower end of the liner 500 onto the opposing end of the wellhead. In particular, a pump 700 may be operated to pump fluid into the annular chamber 416 thereby pressurizing the portion of the annular chamber 416 above the top end face of the tubular actuating sleeve 404.

As a result of the pressurizing of the portion of the annular chamber 416 above the top end face of the tubular actuating sleeve 404, the tubular actuating sleeve is displaced in a downward direction relative to the locking dogs 422 thereby impacting and displacing the locking dogs radially inwardly through the annular window 414 into engagement with the profiled external surface 600b of the wellhead 600. The downward displacement of the tubular actuating sleeve 404 further causes the inner surface of the tubular actuating sleeve to surround and engage the outer surface of the locking dogs 422 thereby preventing the locking dogs from being disengaged from the profiled external surface 600b of the wellhead 600. In an exemplary embodiment, during the downward displacement of the tubular actuating sleeve 404, fluid is drained from the piston chamber 418 through radial passages and longitudinal passages (not shown).

As illustrated in FIG. 7, during the operation of the assembly 400 to radially displace the locking dogs 422 into engagement with the profiled external surface 600b of the wellhead 600, the ends 422a of the locking dogs are supported on the ends 420b of the load transfer elements 420. In an exemplary embodiment, during the operation of the assembly 400 to radially displace the locking dogs 422 into engagement with the profiled external surface 600b, the locking dogs slide on the exterior surfaces of the ends 420b of the load transfer elements 420 into engagement with the profiled external surface 600b of the wellhead 600.

In an exemplary embodiment, the assembly 400 may be disengaged from the wellhead 600 by displacing the locking dogs 422 radially outward by displacing the tubular actuating sleeve 404 upwardly by pressurizing the annular chamber 418 using a pump. In this manner, one or both of the annular pistons, 406 and 408, may be displaced upwardly into engagement with the lower end of the tubular actuating sleeve 404 thereby displacing the tubular actuating sleeve upwardly and displacing the locking dogs 422 radially outward and out of engagement with the wellhead 600.

It is understood that variations may be made in the above without departing from the scope of the invention. Further, spatial references are for the purpose of illustration only and do not limit the specific orientation or location of the structure described above. While specific embodiments have been shown and described, modifications can be made by one skilled in the art without departing from the spirit or teaching of this invention. The embodiments as described are exemplary only and are not limiting. Many variations and modifications are possible and are within the scope of the invention. Accordingly, the scope of protection is not limited to the embodiments described, but is only limited by the claims that follow, the scope of which shall include all equivalents of the subject matter of the claims.

1. A tie back liner connector assembly for connecting an end of a liner to a wellhead having: an external profiled surface and a landing shoulder, comprising:
a tubular housing adapted to be coupled to the end of the liner that defines one or more interior windows; and
one or more locking dogs movably coupled to the tubular housing adapted for displacement through corresponding interior windows of the tubular housing for engagement with the external profiled surface of the wellhead.

2. The assembly of claim 1, further comprising:
one or more linking elements pivotally coupled to the tubular housing and operably coupled to corresponding locking dogs.

3. The assembly of claim 2, wherein the linking elements are adapted to provide an increasing load angle as the locking dogs are displaced through the corresponding windows into engagement with the external profiled surface of the wellhead.

4. The assembly of claim 1, further comprising a shock absorber assembly coupled to an end of the housing for absorbing shock when the end of the connector assembly engages the wellhead.

5. The assembly of claim 1, further comprising an hydraulic actuator operably coupled to the tubular housing for displacing the locking dogs relative to the tubular housing and through the corresponding windows to engage the external profiled surface of the wellhead.

6. The assembly of claim 5, wherein the hydraulic actuator comprises a first annular piston operable for displacing the locking dogs relative to the tubular housing and through the corresponding windows to engage the external profiled surface of the wellhead; and at least one second annular piston operable for displacing the locking dogs relative to the tubular housing and through the corresponding windows to disengage from the external profiled surface of the wellhead.

7. The assembly of claim 5, wherein the hydraulic actuator comprises a first annular piston operable for displacing the locking dogs relative to the tubular housing and through the corresponding windows to engage the external profiled surface of the wellhead; and a plurality of second annular pistons operable for displacing the locking dogs relative to the tubular housing and through the corresponding windows to disengage from the external profiled surface of the wellhead.

8. A method for connecting a lower end of a liner to a wellhead having an external profiled surface and a landing shoulder, comprising:
coupling a tubular housing and one or more locking elements to the end of the liner;
positioning a lower end of the tubular housing next to an upper end of the wellhead;
engaging the lower end of the tubular housing with the wellhead until a lower end face of the liner is positioned proximate an upper end face of the wellhead; and
displacing the locking elements relative to the lower end of the liner through interior windows defined within the tubular housing and into engagement with the external profiled surface of the wellhead.

9. The method of claim 8, wherein displacing the locking elements relative to the lower end of the liner through interior windows defined within the tubular housing and into engagement with the external profiled surface of the wellhead comprises increasing a load angle of the locking elements as they are displaced in the direction of the external profiled surface of the wellhead.

10. The method of claim 8, further comprising absorbing energy during the engaging of the lower end of the tubular housing with the wellhead.

11. The method of claim 8, further comprising displacing the locking elements relative to the lower end of the liner through interior windows defined within the tubular housing and into engagement with the external profiled surface of the wellhead by operating an hydraulic actuator.

12. The method of claim 11, wherein the hydraulic actuator comprises a first annular piston for displacing the locking elements relative to the lower end of the liner through interior windows defined within the tubular housing and into engagement with the external profiled surface of the wellhead.

13. The method of claim 11, wherein the hydraulic actuator further comprises at least one second annular piston for displacing the locking elements relative to the lower end of the liner through interior windows defined within the tubular housing and out of engagement with the external profiled surface of the wellhead.

14. A tie back liner connector assembly for connecting an end of a liner to a wellhead having an external profiled surface and a landing shoulder, comprising:
a tubular housing adapted to be coupled to the end of the liner;
one or more locking dogs movably coupled to the tubular housing adapted for displacement thereto into engagement with the external profiled surface of the wellhead; and
one or more linking elements pivotally coupled to the tubular housing and operably coupled to corresponding locking dogs for transferring loads from the tubular housing to the locking dogs.

15. The assembly of claim 14, further comprising:
an actuator operably coupled to the tubular housing for displacing the locking dogs relative to the tubular housing to engage the external profiled surface of the wellhead; and
a shock absorber assembly coupled to an end of the housing for absorbing shock when the end of the connector assembly engages the wellhead.

16. The assembly of claim 15, wherein the shock absorber assembly comprises a spring element and a damper element.

17. The assembly of claim 15, wherein the shock absorber comprises an annular chamber and a flow passage for controllably permitting fluidic materials to be exhausted from the annular chamber.

18. The assembly of claim 14, wherein the linking elements are adapted to provide an increasing load angle as the locking dogs are displaced through corresponding internal windows defined in the tubular housing into engagement with the external profiled surface of the wellhead.

19. A method for connecting a lower end of a liner to a wellhead having an external profiled surface and a landing shoulder, comprising:
coupling a tubular housing and one or more locking elements to the end of the liner;
positioning a lower end of the tubular housing next to an upper end of the wellhead;
engaging the lower end of the tubular housing with the wellhead until a lower end face of the liner is positioned proximate an upper end face of the wellhead;
displacing the locking elements relative to the lower end of the liner into engagement with the external profiled surface of the wellhead by operating the actuator; and
during the displacement of the locking elements, transferring loads from the tubular housing to the locking elements using one or more pivotal load transfer elements.

20. The method of claim 19, further comprising absorbing energy during the engaging of the lower end of the tubular housing with the wellhead.

21. The method of claim 20, wherein absorbing energy during the engaging of the lower end of the tubular housing with the wellhead comprises preventing shock loading on the lower end of the tubular housing and the wellhead.

22. The method of claim 20, wherein absorbing energy during the engaging of the lower end of the tubular housing with the wellhead comprises limiting a flow rate of fluidic materials out of an annular chamber.

23. A tie back liner connector assembly for connecting an end of a liner to a wellhead having an external profiled surface and a landing shoulder, comprising:
a tubular housing adapted to be coupled to the end of the liner;
one or more locking elements movably coupled to the tubular housing adapted for displacement thereto into engagement with the external profiled surface of the wellhead; and
a shock absorber assembly coupled to an end of the housing for absorbing shock when the end of the connector assembly engages the wellhead.

24. The assembly of claim 23, further comprising:
an actuator operably coupled to the tubular housing for displacing the locking elements relative to the tubular housing to engage the external profiled surface of the wellhead.

25. The assembly of claim 23, wherein the shock absorber assembly comprises a spring element and a damper element.

26. The assembly of claim 23, wherein the shock absorber comprises an annular chamber and a flow passage for controllably permitting fluidic materials to be exhausted from the annular chamber.

27. The assembly of claim 23, further comprising one or more linking elements pivotally coupled to the tubular housing and operably coupled to corresponding locking dogs for transferring loads from the tubular housing to the locking dogs.

28. The assembly of claim 27, wherein the linking elements are adapted to provide an increasing load angle as the locking dogs are displaced through corresponding internal windows defined in the tubular housing into engagement with the external profiled surface of the wellhead.

29. A method for connecting a lower end of a liner to a wellhead having an external profiled surface and a landing shoulder, comprising:
coupling a tubular housing and one or more locking elements to the end of the liner;
positioning a lower end of the tubular housing next to an upper end of the wellhead;
engaging the lower end of the tubular housing with the wellhead until a lower end face of the liner is positioned proximate an upper end face of the wellhead;
displacing the locking elements relative to the lower end of the liner into engagement with the external profiled surface of the wellhead by operating the actuator; and
absorbing energy during the engaging of the lower end of the tubular housing with the wellhead.

30. The method of claim 29, further comprising during the displacement of the locking elements, transferring loads from the tubular housing to the locking elements using one or more pivotal load transfer elements.

31. The method of claim 29, wherein absorbing energy during the engaging of the lower end of the tubular housing with the wellhead comprises preventing shock loading on the lower end of the tubular housing and the wellhead.

32. The method of claim 29, wherein absorbing energy during the engaging of the lower end of the tubular housing with the wellhead comprises limiting a flow rate of fluidic materials out of an annular chamber.
